(19) United States
(12) Patent Application Publication
(10) Pub. No.: US 2017/0112087 A1
(43) Pub. Date: Apr. 27, 2017

(54) HEATED ANIMAL SHELTER ASSEMBLY

(71) Applicant: Ernest Hargress, Inkster, MI (US)

(72) Inventor: Ernest Hargress, Inkster, MI (US)

(21) Appl. No.: 14/923,646

(22) Filed: Oct. 27, 2015

(51) Int. Cl. A01K 1/00; H02S 40/38; H01M 10/46; A01K 29/00

(52) U.S. Cl. CPC A01K 1/0076; A01K 1/0052; A01K 29/005; H02S 40/38; H01M 10/465; H01M 2220/10

(57) ABSTRACT

A heated animal shelter assembly for providing heated shelter for an animal includes a house that may provide shelter for an animal. A heating unit is coupled to the house. The heating unit selectively heats the house. Thus, the house keeps the animal warm when the animal seeks shelter within the house. A pair of doors is provided and each of the doors is hingedly coupled to the house.

### BACKGROUND OF THE DISCLOSURE

### Field of the Disclosure

The disclosure relates to shelter devices and more particularly pertains to a new shelter device for providing heated shelter for an animal.

### SUMMARY OF THE DISCLOSURE

An embodiment of the disclosure meets the needs presented above by generally comprising a house that may provide shelter for an animal. A heating unit is coupled to the house. The heating unit selectively heats the house. Thus, the house keeps the animal warm when the animal seeks shelter within the house. A pair of doors is provided and each of the doors is hingedly coupled to the house.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a front perspective view of a heated animal shelter assembly according to an embodiment of the disclosure.

FIG. 2 is a front phantom view of an embodiment of the disclosure.

FIG. 3 is a right side phantom of an embodiment of the disclosure.

FIG. 4 is a cross sectional view taken along line 4-4 of FIG. 3 of an embodiment of the disclosure.

FIG. 5 is a cross sectional view taken along line 5-5 of FIG. 2 of an embodiment of the disclosure.

### DESCRIPTION OF THE PREFERRED EMBODIMENT

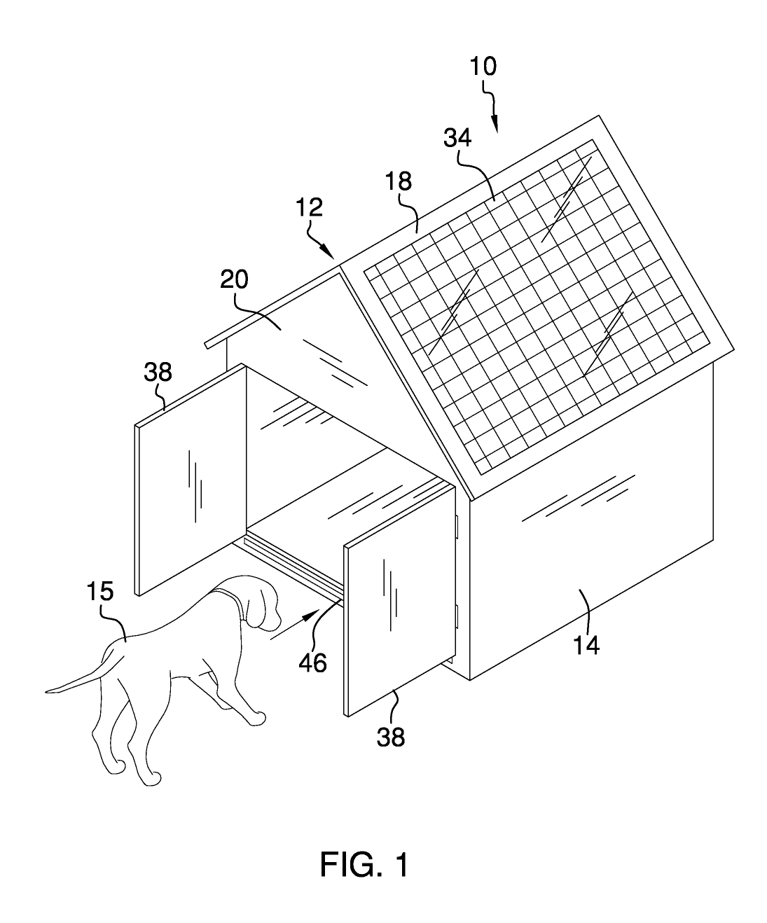

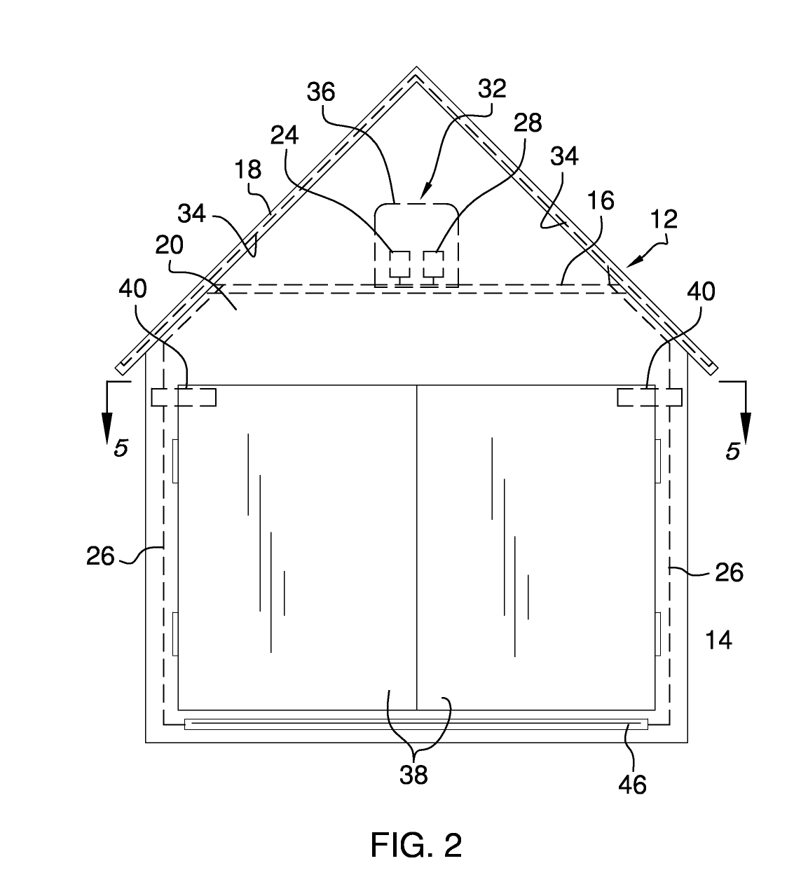

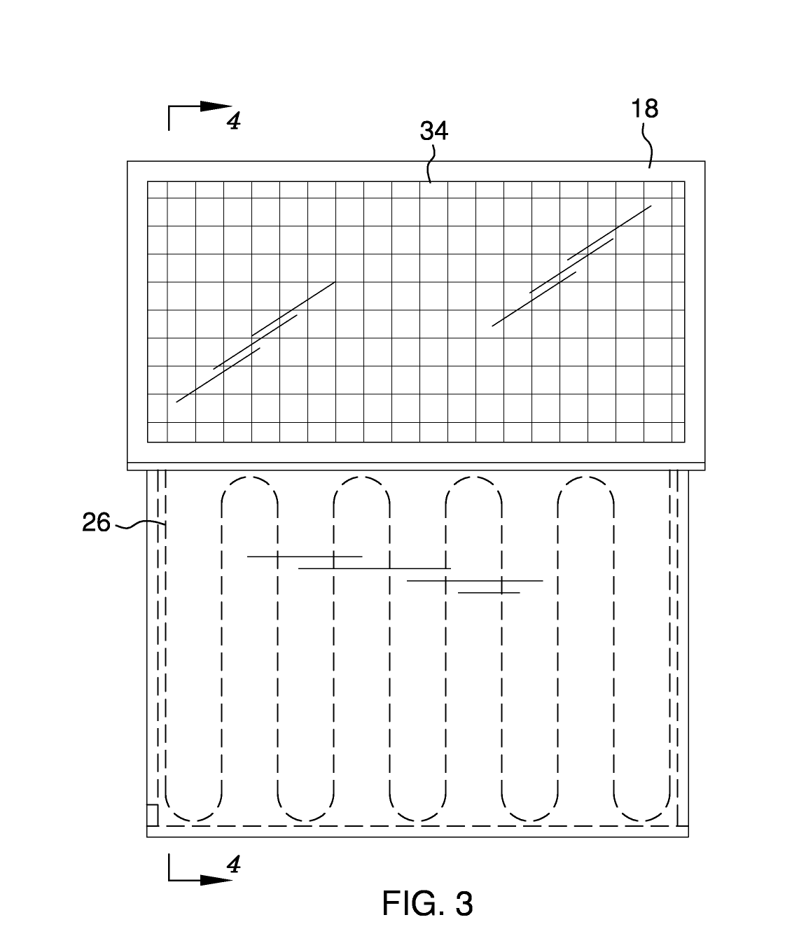

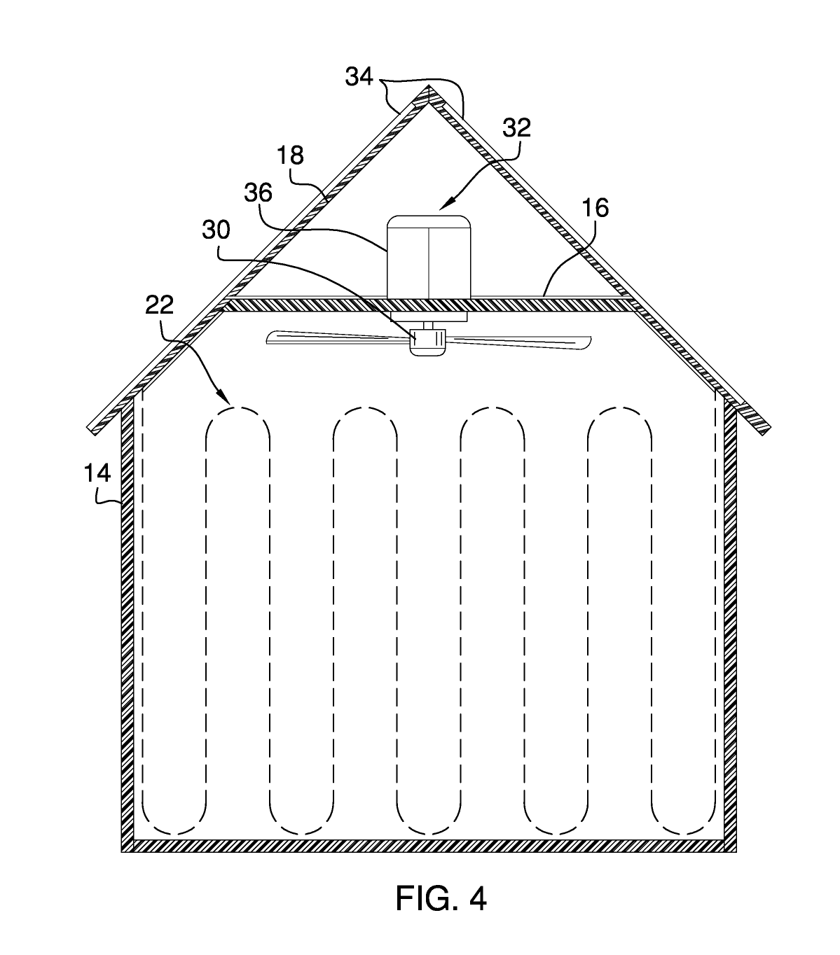

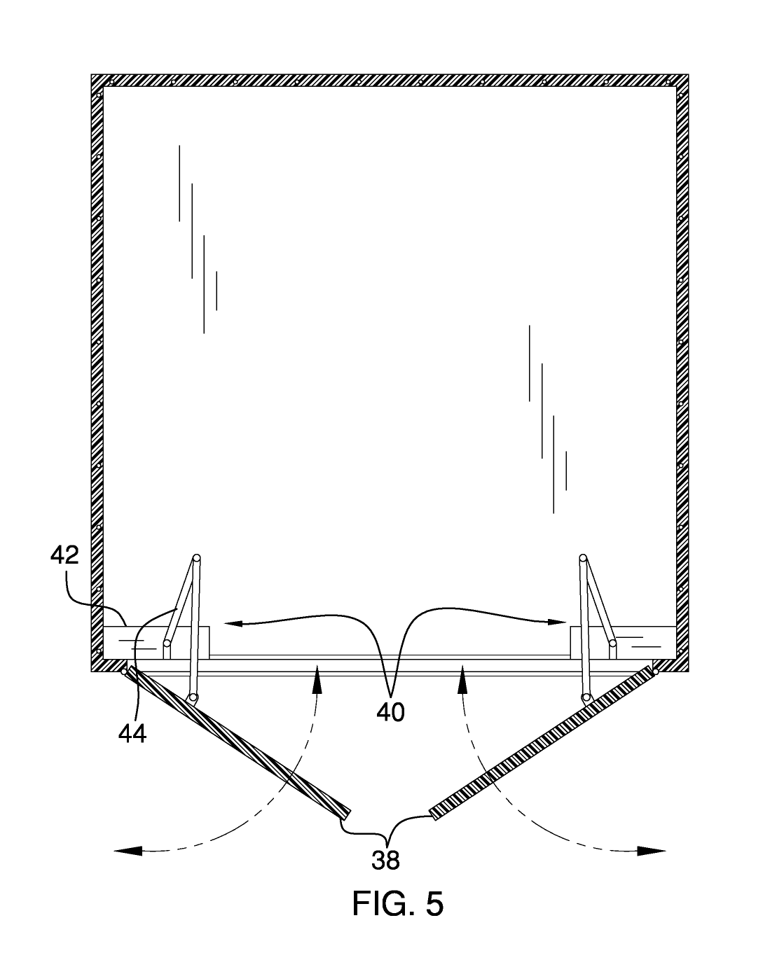

With reference now to the drawings, and in particular to FIGS. 1 through 5 thereof, a new shelter device embodying the principles and concepts of an embodiment of the disclosure and generally designated by the reference numeral 10 will be described.

As best illustrated in FIGS. 1 through 5, the heated animal shelter assembly 10 generally comprises a house 12 that may provide shelter for an animal 15. The animal 15 may be a canine or the like. The house 12 has an outer wall 14, a ceiling 16 and a roof 18. The outer wall 14 has a front side 20 and the front side 20 is open to access an interior of the house 12. A heating unit 22 is coupled to the house 12 and the heating unit 22 selectively heats the house 12. Thus, the house 12 keeps the animal 15 warm when the animal 15 seeks shelter within the house 12.

The heating unit 22 comprises a processor 24 that is coupled to the house 12. A heating coil 26 is coupled to the house 12. The heating coil 26 is positioned within the outer wall 14 such that the heating coil 26 selectively heats the outer wall 14 The outer wall 14 transfers the heat to an interior of the house 12. The heating coil 26 is substantially coextensive with the outer wall 14. The heating coil 26 is electrically coupled to the processor 24 such that the processor 24 selectively turns the heating coil 26 on and off. The heating coil 26 may comprise an electrical heating coil or the like with an operational temperature that may range between approximately 60° Fahrenheit and 80° Fahrenheit.

A temperature sensor 28 is coupled to the house 12 and the temperature sensor is in thermal communication with the interior of the house 12. The temperature sensor 28 detects an ambient temperature within the house 12. The temperature sensor 28 is electrically coupled to the processor 24 and the processor 24 turns the heating coil 26 off when the ambient temperature reaches a maximum temperature. The processor 24 turns the heating coil 26 on when the ambient temperature falls below a minimum temperature. The maximum temperature may be approximately 80° Fahrenheit and the minimum temperature may be approximately 60° Fahrenheit. The processor 24 may comprise an electronic processor or the like.

A fan 30 is coupled to the ceiling 16 and the fan 30 selectively circulates air within the interior of the house 12. The fan 30 is electrically coupled to the processor 24 such that the processor 24 turns the fan 30 on and off. The fan 30 is turned on when the ambient temperature in the house 12 exceeds the maximum temperature. The fan 30 may comprise an electric ceiling fan or the like.

A power supply 32 is coupled to the house 12 and the power supply 32 is electrically coupled to the processor 24. The power supply 32 comprises a plurality of solar panels 34 and each of the solar panels 34 is coupled to the roof 18. Thus, each of the solar panels 34 is exposed to solar energy thereby facilitating each of the solar panels 34 to convert the solar energy to electrical energy. At least one battery 36 is positioned within the house 12. The at least one battery 36 is electrically coupled to each of the solar panels 34 such that the solar panels 34 charge the at least one battery 36. The at least one battery 36 is electrically coupled to the processor 24.

A pair of doors 38 is provided and each of the doors 38 is hingedly coupled to the house 12. Each of the doors 38 is positioned on the front side 20 and each of the doors 38 is positionable between an open position and a closed position. A pair of openers 40 is provided and each of the openers 40 may include an actuator 42 and an arm 44 that is mechanically coupled to the actuator 42. The actuator 42 urges the arm 44 and the actuator 42 corresponding to each of the openers 40 is coupled to the house 12.

The arm 44 corresponding to each of the openers 40 is mechanically coupled to an associated one of the doors 38. Thus, each of the openers 40 urges the associated door 38 between the open position and the closed position. The actuator 42 corresponding to each of the openers 40 is electrically coupled to the processor 24. Each of the openers 40 may comprise an electric door opener or the like.

A motion sensor 46 is coupled to the house 12. The motion sensor 46 detects when the animal 15 approaches the house 12. The motion sensor 46 is positioned on the front side 20 of the house 12 and the motion sensor 46 is electrically coupled to the processor 24. Each of the openers 40 urges the associated door 38 into the open position when the animal 15 approaches the front side 20. The motion sensor 46 may have an operational range between approximately two meters and three meters. The motion sensor 46 may comprise an electronic motion sensor or the like.

In use, the solar panels 34 convert solar energy into electrical energy and the solar panels 34 charge the at least one battery 36. The processor 24 actuates the heating coil 26 to maintain the ambient temperature in the house 12 between the minimum temperature and the maximum temperature. The openers 40 open the doors 38 when the motion sensor 46 detects when the animal 15 approaches the house 12. The animal 15 enters the house 12 and the openers 40 close the doors 38 after a pre-determined duration of time. The animal 15 may manually open the doors 38 at any time.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A heated animal shelter assembly comprising:
a house being configured to provide shelter for an animal, said house having a front side;
a heating unit being coupled to said house, said heating unit selectively heating said house wherein said house is configured to keep the animal warm when said animal seeks shelter within said house; and
a pair of doors, each of said doors being hingedly coupled to said house, each of said doors being positioned on said front side, each of said doors being positionable between an open position and a closed position; and
a pair of openers, each of said openers being coupled to said house, each of said openers being mechanically coupled to an associated one of said doors such that each of said openers urges said associated door between said open position and said closed position, each of said openers being electrically coupled to a processor.

2. The assembly according to claim 1, wherein:
said house has an outer wall; and
said heating unit comprises
a processor being coupled to said house; and
a heating coil being coupled to said house, said heating coil being positioned within said outer wall such that said heating coil selectively heats an interior of said house, said heating coil being substantially coextensive with said outer wall, said heating coil being electrically coupled to said processor such that said processor selectively turns said heating coil on and off.

3. The assembly according to claim 2, further comprising a temperature sensor being coupled to said house wherein said temperature sensor is configured to detect an ambient temperature within said house, said temperature sensor being electrically coupled to said processor wherein said processor is configured to turn said heating coil off when the ambient temperature reaches a maximum temperature, said processor being configured to turn said heating coil on when the ambient temperature falls below a minimum temperature.

4. The assembly according to claim 3, further comprising a fan being coupled to said ceiling wherein said fan is configured to circulate air within said interior of said house, said fan being electrically coupled to said processor such that said processor turns said fan on and off.

5. A heated animal shelter assembly comprising:
a house being configured to provide shelter for an animal, said house having an outer wall and a roof;
a heating unit being coupled to said house, said heating unit selectively heating said house wherein said house is configured to keep the animal warm when said animal seeks shelter within said house;
a pair of doors, each of said doors being hingedly coupled to said house;
said heating unit comprising
a processor being coupled to said house, and
a heating coil being coupled to said house, said heating coil being positioned within said outer wall such that said heating coil selectively heats an interior of said house, said heating coil being substantially coextensive with said outer wall, said heating coil being electrically coupled to said processor such that said processor selectively turns said heating coil on and off;
a power supply being coupled to said house, said power supply being electrically coupled to said processor, said power supply comprising:
a plurality of solar panels, each of said plurality of solar panels being coupled to said roof wherein each of said solar panels is configured to be exposed to solar energy thereby facilitating each of said solar panels to convert the solar energy to electrical energy; and
at least one battery being positioned within said house, said at least one battery being electrically coupled to each of said solar panels such that said solar panels charge said at least one battery, said at least one battery being electrically coupled to said processor.

6. (canceled)

7. The assembly according to claim 1, further comprising a motion sensor being coupled to said house wherein said motion sensor is configured to detect the animal approaching said house, said motion sensor being positioned on said front side of said house, said motion sensor being electrically coupled to said processor wherein each of said openers is configured to urge said associated door into said open position when the animal approaches said front side.

8. A heated animal shelter assembly comprising:
a house being configured to provide shelter for an animal, said house having an outer wall, a ceiling and a roof, said outer wall having a front side, said front side being open to access an interior of said house;
a heating unit being coupled to said house, said heating unit selectively heating said house wherein said house is configured to keep the animal warm when said animal seeks shelter within said house, said heating unit comprising:
a processor being coupled to said house,
a heating coil being coupled to said house, said heating coil being positioned within said outer wall such that said heating coil selectively heats an interior of said house, said heating coil being substantially coextensive with said outer wall, said heating coil being electrically coupled to said processor such that said processor selectively turns said heating coil on and off,
a temperature sensor being coupled to said house wherein said temperature sensor is configured to detect an ambient temperature within said house, said temperature sensor being electrically coupled to said processor wherein said processor is configured to turn said heating coil off when the ambient temperature reaches a maximum temperature, said processor being configured to turn said heating coil on when the ambient temperature falls below a minimum temperature,
a fan being coupled to said ceiling wherein said fan is configured to circulate air within said interior of said house, said fan being electrically coupled to said processor such that said processor turns said fan on and off, and
a power supply being coupled to said house, said power supply being electrically coupled to said processor said power supply comprising:
a plurality of solar panels, each of said plurality of solar panels being coupled to said roof wherein each of said solar panels is configured to be exposed to solar energy thereby facilitating each of said solar panels to convert the solar energy to electrical energy, and
at least one battery being positioned within said house, said at least one battery being electrically coupled to each of said solar panels such that said solar panels charge said at least one battery, said at least one battery being electrically coupled to said processor;
a pair of doors, each of said doors being hingedly coupled to said house, each of said doors being positioned on said front side, each of said doors being positionable between an open position and a closed position;
a pair of openers, each of said openers being coupled to said house, each of said openers being mechanically coupled to an associated one of said doors such that each of said openers urges said associated door between said open position and said closed position, each of said openers being electrically coupled to said processor; and
a motion sensor being coupled to said house wherein said motion sensor is configured to detect the animal approaching said house, said motion sensor being positioned on said front side of said house, said motion sensor being electrically coupled to said processor wherein each of said openers is configured to urge said associated door into said open position when the animal approaches said front side.
